(19) United States
(12) Patent Application Publication
(10) Pub. No.: US 2022/0108648 A1
(43) Pub. Date: Apr. 7, 2022

(54) ELECTRO-OPTIC DISPLAYS, AND METHODS FOR DRIVING SAME

(71) Applicant: E INK CORPORATION, Billerica, MA (US)

(72) Inventors: Yuval BEN-DOV, Cambridge, MA (US); Teck Ping SIM, Acton, MA (US); Kenneth A. CROUNSE, Somerville, MA (US)

(21) Appl. No.: 17/490,218

(22) Filed: Sep. 30, 2021

Related U.S. Application Data
(60) Provisional application No. 63/086,118, filed on Oct. 1, 2020.

(51) Int. Cl. G09G 3/20; G09G 3/34

(52) U.S. Cl. CPC G09G 3/2044; G09G 2310/068; G09G 2310/0256; G09G 3/344

(57) ABSTRACT

A method for driving an electro-optic display having a plurality of display pixels, the method includes dithering a grayscale image into a black and white image, updating the plurality of display pixels to display the black and white image, and converting the black and white image back to the grayscale image.

### REFERENCE TO RELATED APPLICATIONS

This application is related to and claims priority to U.S. Provisional Application 63/086,118 filed on Oct. 1, 2020.

The entire disclosures of the aforementioned application is herein incorporated by reference.

### SUBJECT OF THE INVENTION

This invention relates to methods for driving electro-optic displays. More specifically, this invention relates to driving methods for displaying videos.

### BACKGROUND

Particle-based electrophoretic displays have been the subject of intense research and development for a number of years. In such displays, a plurality of charged particles (sometimes referred to as pigment particles) move through a fluid under the influence of an electric field. The electric field is typically provided by a conductive film or a transistor, such as a field-effect transistor. Electrophoretic displays have good brightness and contrast, wide viewing angles, state bistability, and low power consumption when compared with liquid crystal displays. Such electrophoretic displays have slower switching speeds than LCD displays. Additionally, the electrophoretic displays can be sluggish at low temperatures because the viscosity of the fluid limits the movement of the electrophoretic particles. Despite these shortcomings, electrophoretic displays can be found in everyday products such as electronic books (e-readers), mobile phones and mobile phone covers, smart cards, signs, watches, shelf labels, and flash drives.

Many commercial electrophoretic media essentially display only two colors, with a gradient between the black and white extremes, known as “grayscale.” Such electrophoretic media either use a single type of electrophoretic particle having a first color in a colored fluid having a second, different color (in which case, the first color is displayed when the particles lie adjacent the viewing surface of the display and the second color is displayed when the particles are spaced from the viewing surface), or first and second types of electrophoretic particles having differing first and second colors in an uncolored fluid. In the latter case, the first color is displayed when the first type of particles lie adjacent the viewing surface of the display and the second color is displayed when the second type of particles lie adjacent the viewing surface). Typically the two colors are black and white.

Although seemingly simple, electrophoretic media and electrophoretic devices display complex behaviors. For instance, it has been discovered that good video displaying requires more than simple “on/off” voltage pulses. Rather, complicated “waveforms” are needed to drive the particles between states and to assure the produced videos are of sufficiently good quality. As such, there exists a need for driving methods to perform video displaying in electrophoretic displays.

### SUMMARY OF INVENTION

This invention provides a method for driving an electro-optic display having a plurality of display pixels, the method includes dithering a grayscale image into a black and white image, updating the plurality of display pixels to display the black and white image, and converting the black and white image back to the grayscale image.

In some embodiments, the method may further include applying a waveform configured to remove artifacts from the plurality of display pixels. In some other embodiments, the step of dithering the grayscale image into a black and white image comprises using a half-toning algorithm. And in another embodiment, the half-toning algorithm is a green noise half-toning algorithm.

### BRIEF DESCRIPTION OF DRAWINGS

FIG. 1 is a circuit diagram representing an electrophoretic display;

FIG. 2 shows a circuit model of the electro-optic imaging layer;

FIG. 3 illustrates an exemplary process for enabling smooth animation update;

FIG. 4A illustrates an example of a half-toning process for converting grayscale images to black and white images;

FIG. 4B illustrates another half-toning process for converting grayscale images to black and white images;

FIG. 4C illustrate yet another half-toning process for converting grayscale images to black and white images;

FIG. 5 illustrates an exemplary process for generating a smooth animation;

FIG. 6 illustrates an exemplary look up table (LUT);

FIG. 7 illustrates an exemplary image state assignments after an image processing algorithm has assigned appropriate waveforms to enable a smooth scrolling animation; and

FIG. 8 illustrates an exemplary sequential image updating process.

### DETAILED DESCRIPTION

The present invention relates to methods for driving electro-optic displays, especially bistable electro-optic displays, and to apparatus for use in such methods. More specifically, this invention relates to driving methods for display vidoes. This invention is especially, but not exclusively, intended for use with particle-based electrophoretic displays in which one or more types of electrically charged particles are present in a fluid and are moved through the fluid under the influence of an electric field to change the appearance of the display.

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

The term “gray state” is used herein in its conventional meaning in the imaging art to refer to a state intermediate two extreme optical states of a pixel, and does not necessarily imply a black-white transition between these two extreme states. For example, several of the E Ink patents and published applications referred to below describe electrophoretic displays in which the extreme states are white and deep blue, so that an intermediate “gray state” would actually be pale blue. Indeed, as already mentioned, the change in optical state may not be a color change at all. The terms “black” and “white” may be used hereinafter to refer to the two extreme optical states of a display, and should be understood as normally including extreme optical states which are not strictly black and white, for example, the aforementioned white and dark blue states. The term “monochrome” may be used hereinafter to denote a drive scheme which only drives pixels to their two extreme optical states with no intervening gray states.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays and encapsulated liquid crystal displays.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

The term “impulse” is used herein in its conventional meaning of the integral of voltage with respect to time. However, some bistable electro-optic media act as charge transducers, and with such media an alternative definition of impulse, namely the integral of current over time (which is equal to the total charge applied) may be used. The appropriate definition of impulse should be used, depending on whether the medium acts as a voltage-time impulse transducer or a charge impulse transducer.

Much of the discussion below will focus on methods for driving one or more pixels of an electro-optic display through a transition from an initial gray level to a final gray level (which may or may not be different from the initial gray level). The term “waveform” will be used to denote the entire voltage against time curve used to effect the transition from one specific initial gray level to a specific final gray level. Typically such a waveform will comprise a plurality of waveform elements; where these elements are essentially rectangular (i.e., where a given element comprises application of a constant voltage for a period of time); the elements may be called “pulses” or “drive pulses”. The term “drive scheme” denotes a set of waveforms sufficient to effect all possible transitions between gray levels for a specific display. A display may make use of more than one drive scheme; for example, the aforementioned U.S. Pat. No. 7,012,600 teaches that a drive scheme may need to be modified depending upon parameters such as the temperature of the display or the time for which it has been in operation during its lifetime, and thus a display may be provided with a plurality of different drive schemes to be used at differing temperature etc. A set of drive schemes used in this manner may be referred to as “a set of related drive schemes.” It is also possible, as described in several of the aforementioned MEDEOD applications, to use more than one drive scheme simultaneously in different areas of the same display, and a set of drive schemes used in this manner may be referred to as “a set of simultaneous drive schemes.”

Several types of electro-optic displays are known. One type of electro-optic display is a rotating bichromal member type as described, for example, in U.S. Pat. Nos. 5,808,783; 5,777,782; 5,760,761; 6,054,071 6,055,091; 6,097,531; 6,128,124; 6,137,467; and 6,147,791 (although this type of display is often referred to as a “rotating bichromal ball” display, the term “rotating bichromal member” is preferred as more accurate since in some of the patents mentioned above the rotating members are not spherical). Such a display uses a large number of small bodies (typically spherical or cylindrical) which have two or more sections with differing optical characteristics, and an internal dipole. These bodies are suspended within liquid-filled vacuoles within a matrix, the vacuoles being filled with liquid so that the bodies are free to rotate. The appearance of the display is changed by applying an electric field thereto, thus rotating the bodies to various positions and varying which of the sections of the bodies is seen through a viewing surface. This type of electro-optic medium is typically bistable.

Another type of electro-optic display uses an electrochromic medium, for example an electrochromic medium in the form of a nanochromic film comprising an electrode formed at least in part from a semi-conducting metal oxide and a plurality of dye molecules capable of reversible color change attached to the electrode; see, for example O'Regan, B., et al., Nature 1991, 353, 737; and Wood, D., Information Display, 18(3), 24 (March 2002). See also Bach, U., et al., Adv. Mater., 2002, 14(11), 845. Nanochromic films of this type are also described, for example, in U.S. Pat. Nos. 6,301,038; 6,870,657; and 6,950,220. This type of medium is also typically bistable.

Another type of electro-optic display is an electro-wetting display developed by Philips and described in Hayes, R.A., et al., “Video-Speed Electronic Paper Based on Electrowetting”, Nature, 425, 383-385 (2003). It is shown in U.S. Pat. No. 7,420,549 that such electro-wetting displays can be made bistable.

One type of electro-optic display, which has been the subject of intense research and development for a number of years, is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, for example, Kitamura, T., et al., “Electrical toner movement for electronic paper-like display”, IDW Japan, 2001, Paper HCS1-1, and Yamaguchi, Y., et al., “Toner display using insulative particles charged triboelectrically”, IDW Japan, 2001, Paper AMD4-4). See also U.S. Pat. Nos. 7,321,459 and 7,236,291. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in these patents and applications include:

(a) Electrophoretic particles, fluids and fluid additives; see for example U.S. Pat. Nos. 7,002,728 and 7,679,814;

(b) Capsules, binders and encapsulation processes; see for example U.S. Pat. Nos. 6,922,276 and 7,411,719;

(c) Microcell structures, wall materials, and methods of forming microcells; see for example U.S. Pat. Nos. 7,072,095 and 9,279,906;

(d) Methods for filling and sealing microcells; see for example U.S. Pat. Nos. 7,144,942 and 7,715,088;

(e) Films and sub-assemblies containing electro-optic materials; see for example U.S. Pat. Nos. 6,982,178 and 7,839,564;

(f) Backplanes, adhesive layers and other auxiliary layers and methods used in displays; see for example U.S. Pat. Nos. 7,116,318 and 7,535,624;

(g) Color formation and color adjustment; see for example U.S. Pat. Nos. 7,075,502 and 7,839,564.

(h) Applications of displays; see for example U.S. Pat. Nos. 7,312,784; 8,009,348;

Non-electrophoretic displays, as described in U.S. Pat. No. 6,241,921 and U.S. Patent Application Publication No. 2015/0277160; and applications of encapsulation and microcell technology other than displays; see for example U.S. Patent Application Publications Nos. 2015/0005720 and 2016/0012710; and

(j) Methods for driving displays; see for example U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. Patent Applications Publication Nos. 2003/0102858; 2004/0246562; 2005/0253777; 2007/0070032; 2007/0076289; 2007/0091418; 2007/0103427; 2007/0176912; 2007/0296452; 2008/0024429; 2008/0024482; 2008/0136774; 2008/0169821; 2008/0218471; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2016/0071465; 2016/0078820; 2016/0093253; 2016/0140910; and 2016/0180777.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned 2002/0131147. Accordingly, for purposes of the present application, such polymer-dispersed electrophoretic media are regarded as sub-species of encapsulated electrophoretic media.

A related type of electrophoretic display is a so-called “microcell electrophoretic display.” In a microcell electrophoretic display, the charged particles and the suspending fluid are not encapsulated within microcapsules but instead are retained within a plurality of cavities formed within a carrier medium, e.g., a polymeric film. See, for example, International Application Publication No. WO 02/01281, and published U.S. Application No. 2002/0075556, both assigned to Sipix Imaging, Inc.

Many of the aforementioned E Ink and MIT patents and applications also contemplate microcell electrophoretic displays and polymer-dispersed electrophoretic displays. The term “encapsulated electrophoretic displays” can refer to all such display types, which may also be described collectively as “microcavity electrophoretic displays” to generalize across the morphology of the walls.

Another type of electro-optic display is an electro-wetting display developed by Philips and described in Hayes, R. A., et al., “Video-Speed Electronic Paper Based on Electrowetting,” Nature, 425, 383-385 (2003). It is shown in copending application Ser. No. 10/711,802, filed Oct. 6, 2004, that such electro-wetting displays can be made bistable.

Other types of electro-optic materials may also be used. Of particular interest, bistable ferroelectric liquid crystal displays (FLCs) are known in the art and have exhibited remnant voltage behavior.

Although electrophoretic media may be opaque (since, for example, in many electrophoretic media, the particles substantially block transmission of visible light through the display) and operate in a reflective mode, some electrophoretic displays can be made to operate in a so-called “shutter mode” in which one display state is substantially opaque and one is light-transmissive. See, for example, the patents U.S. Pat. Nos. 6,130,774 and 6,172,798, and U.S. Pat. Nos. 5,872,552; 6,144,361; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode.

A high-resolution display may include individual pixels which are addressable without interference from adjacent pixels. One way to obtain such pixels is to provide an array of non-linear elements, such as transistors or diodes, with at least one non-linear element associated with each pixel, to produce an “active matrix” display. An addressing or pixel electrode, which addresses one pixel, is connected to an appropriate voltage source through the associated non-linear element. When the non-linear element is a transistor, the pixel electrode may be connected to the drain of the transistor, and this arrangement will be assumed in the following description, although it is essentially arbitrary and the pixel electrode could be connected to the source of the transistor. In high-resolution arrays, the pixels may be arranged in a two-dimensional array of rows and columns, such that any specific pixel is uniquely defined by the intersection of one specified row and one specified column. The sources of all the transistors in each column may be connected to a single column electrode, while the gates of all the transistors in each row may be connected to a single row electrode; again the assignment of sources to rows and gates to columns may be reversed if desired.

The display may be written in a row-by-row manner. The row electrodes are connected to a row driver, which may apply to a selected row electrode a voltage such as to ensure that all the transistors in the selected row are conductive, while applying to all other rows a voltage such as to ensure that all the transistors in these non-selected rows remain non-conductive. The column electrodes are connected to column drivers, which place upon the various column electrodes voltages selected to drive the pixels in a selected row to their desired optical states. (The aforementioned voltages are relative to a common front electrode which may be provided on the opposed side of the electro-optic medium from the non-linear array and extends across the whole display. As in known in the art, voltage is relative and a measure of a charge differential between two points. One voltage value is relative to another voltage value. For example, zero voltage (“OV”) refers to having no voltage differential relative to another voltage.) After a pre-selected interval known as the “line address time,” a selected row is deselected, another row is selected, and the voltages on the column drivers are changed so that the next line of the display is written.

However, in use, certain waveforms may produce a remnant voltage to pixels of an electro-optic display, and as evident from the discussion above, this remnant voltage produces several unwanted optical effects and is in general undesirable.

As presented herein, a “shift” in the optical state associated with an addressing pulse refers to a situation in which a first application of a particular addressing pulse to an electro-optic display results in a first optical state (e.g., a first gray tone), and a subsequent application of the same addressing pulse to the electro-optic display results in a second optical state (e.g., a second gray tone). Remnant voltages may give rise to shifts in the optical state because the voltage applied to a pixel of the electro-optic display during application of an addressing pulse includes the sum of the remnant voltage and the voltage of the addressing pulse.

A “drift” in the optical state of a display over time refers to a situation in which the optical state of an electro-optic display changes while the display is at rest (e.g., during a period in which an addressing pulse is not applied to the display). Remnant voltages may give rise to drifts in the optical state because the optical state of a pixel may depend on the pixel's remnant voltage, and a pixel's remnant voltage may decay over time.

The “ghosting” effect refers to a situation in which, after the electro-optic display has been rewritten, traces of the previous image(s) are still visible. Remnant voltages may give rise to “edge ghosting,” a type of ghosting in which an outline (edge) of a portion of a previous image remains visible.

An exemplary EPD

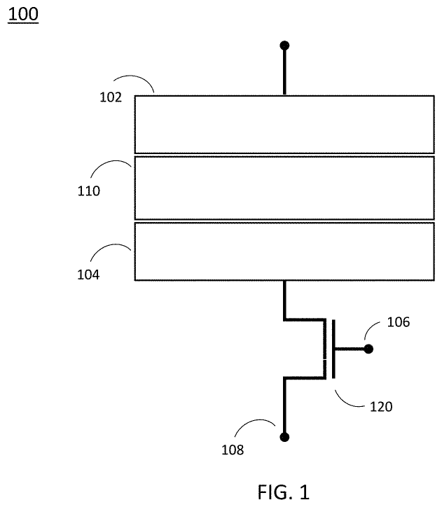

FIG. 1 shows a schematic of a pixel 100 of an electro-optic display in accordance with the subject matter submitted herein. Pixel 100 may include an imaging film 110. In some embodiments, imaging film 110 may be bistable. In some embodiments, imaging film 110 may include, without limitation, an encapsulated electrophoretic imaging film, which may include, for example, charged pigment particles.

Imaging film 110 may be disposed between a front electrode 102 and a rear electrode 104. Front electrode 102 may be formed between the imaging film and the front of the display. In some embodiments, front electrode 102 may be transparent. In some embodiments, front electrode 102 may be formed of any suitable transparent material, including, without limitation, indium tin oxide (ITO). Rear electrode 104 may be formed opposite a front electrode 102. In some embodiments, a parasitic capacitance (not shown) may be formed between front electrode 102 and rear electrode 104.

Pixel 100 may be one of a plurality of pixels. The plurality of pixels may be arranged in a two-dimensional array of rows and columns to form a matrix, such that any specific pixel is uniquely defined by the intersection of one specified row and one specified column. In some embodiments, the matrix of pixels may be an “active matrix,” in which each pixel is associated with at least one non-linear circuit element 120. The non-linear circuit element 120 may be coupled between back-plate electrode 104 and an addressing electrode 108. In some embodiments, non-linear element 120 may include a diode and/or a transistor, including, without limitation, a MOSFET. The drain (or source) of the MOSFET may be coupled to back-plate electrode 104, the source (or drain) of the MOSFET may be coupled to addressing electrode 108, and the gate of the MOSFET may be coupled to a driver electrode 106 configured to control the activation and deactivation of the MOSFET. (For simplicity, the terminal of the MOSFET coupled to back-plate electrode 104 will be referred to as the MOSFET's drain, and the terminal of the MOSFET coupled to addressing electrode 108 will be referred to as the MOSFET's source. However, one of ordinary skill in the art will recognize that, in some embodiments, the source and drain of the MOSFET may be interchanged.)

In some embodiments of the active matrix, the addressing electrodes 108 of all the pixels in each column may be connected to a same column electrode, and the driver electrodes 106 of all the pixels in each row may be connected to a same row electrode. The row electrodes may be connected to a row driver, which may select one or more rows of pixels by applying to the selected row electrodes a voltage sufficient to activate the non-linear elements 120 of all the pixels 100 in the selected row(s). The column electrodes may be connected to column drivers, which may place upon the addressing electrode 106 of a selected (activated) pixel a voltage suitable for driving the pixel into a desired optical state. The voltage applied to an addressing electrode 108 may be relative to the voltage applied to the pixel's front-plate electrode 102 (e.g., a voltage of approximately zero volts). In some embodiments, the front-plate electrodes 102 of all the pixels in the active matrix may be coupled to a common electrode.

In some embodiments, the pixels 100 of the active matrix may be written in a row-by-row manner. For example, a row of pixels may be selected by the row driver, and the voltages corresponding to the desired optical states for the row of pixels may be applied to the pixels by the column drivers. After a pre-selected interval known as the “line address time,” the selected row may be deselected, another row may be selected, and the voltages on the column drivers may be changed so that another line of the display is written.

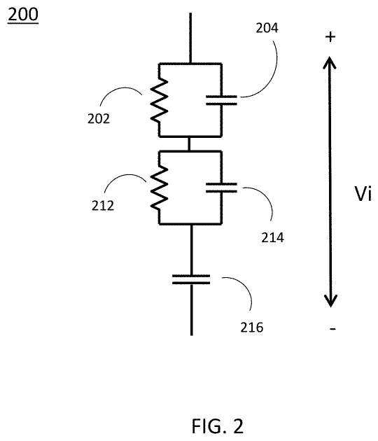

FIG. 2 shows a circuit model of the electro-optic imaging layer 110 disposed between the front electrode 102 and the rear electrode 104 in accordance with the subject matter presented herein. Resistor 202 and capacitor 204 may represent the resistance and capacitance of the electro-optic imaging layer 110, the front electrode 102 and the rear electrode 104, including any adhesive layers. Resistor 212 and capacitor 214 may represent the resistance and capacitance of a lamination adhesive layer. Capacitor 216 may represent a capacitance that may form between the front electrode 102 and the back electrode 104, for example, interfacial contact areas between layers, such as the interface between the imaging layer and the lamination adhesive layer and/or between the lamination adhesive layer and the backplane electrode. A voltage Vi across a pixel's imaging film 110 may include the pixel's remnant voltage.

In practice, conventional video rate displays using non-bistable media, such as the phosphors on cathode ray tubes and conventional liquid crystal displays, require frame rates in excess of about 25 frames per second (fps) to provide acceptable video quality. (Video display at 15 fps is common on internet videos but results in a noticeable lack of video quality.) However, it is been found that bistable, and certain other, electro-optic displays can produce good quality images at frame rates substantially below 25 fps, and in the range of about 10 to about 20 fps, preferably about 13 to about 20 fps. Experienced observers have determined that encapsulated electrophoretic displays running at 15 fps can produce video quality which appears substantially equal to that produced by non-bistable displays running at about 30 fps.

There are many possible reasons for this unexpectedly high video quality at low frame rates, one being that it appears that part of the explanation lies in the manner in which the persistent image on a bistable display assists the eye in “blending” successive images to create the illusion of motion. All video displays rely upon the ability of the eye to blend a series of still images to create the illusion of motion. However, many types of video display actually introduce transient intervening “images” which hinder the blending process. For example, a motion film display using a mechanical film projector actually places a first static image on the screen, then displays a blank screen for a very short period as the projector advances the film to the next frame, and thereafter displays a second static image.

The subject matter presented herein includes driving methods that utilizes interruptible waveform updates while maintaining a substantial DC balance, meaning, the net resulting impulse from the updating is substantially zero, thereby allowing for a smooth pipeline animation updating. In some embodiments, driving methods presented herein further provides strategies to address the ghosting effect. Where as described above, “ghosting” refers to a situation in which, after the electro-optic display has been rewritten, traces of the previous image(s) are still visible. Remnant voltages may give rise to “edge ghosting,” a type of ghosting in which an outline (edge) of a portion of a previous image remains visible.

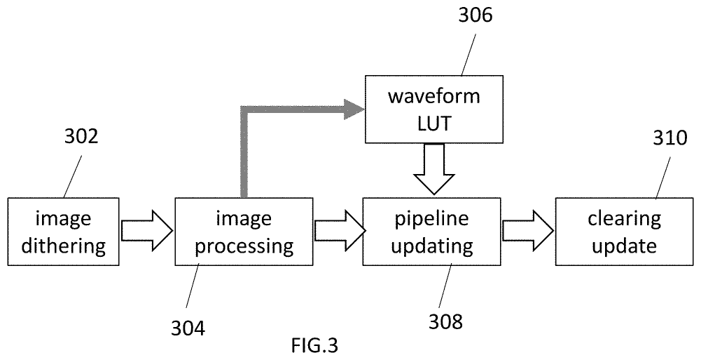

Referring now to FIG. 3, illustrated in FIG. 3 is a flow chart of a driving process 300 for enabling smooth animation update in accordance with the subject matter disclosed herein. This process 300 may include a first step 302 at which a grayscale image is dithered into a black and white image. Subsequently, the dithered image is process in an image processing step 304, where the image processing step 304 can include animating the dithered image using pipeline/concurrent updating capability of a controller associated with the electro-optic display. In some embodiments, a 5-bit waveform look up table (LUT) (e.g., step 306) may be used to implement an interruptible direct updating strategy (e.g., Step 308) while maintaining a DC balance that allows for smooth updating. In addition, in some embodiments, a specialized waveform may be used to clear any ghosting artifacts in a clearing update date 310.

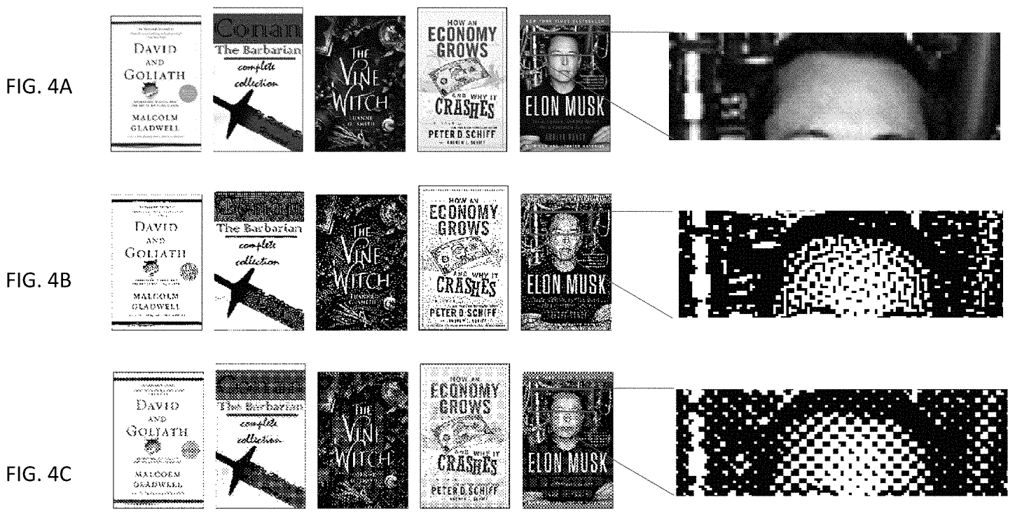

In practice, the dithering step 302 of FIG. 3 may process a grayscale image (e.g., FIG. 4a) to a black and white only image that closely duplicate the original image by using half-toning algorithms commonly used in the art such as a green noise half-toning algorithm (e.g., FIG. 4b) and/or a clustered half-toning map (e.g., FIG. 4c). In some embodiments, for applications of animation displaying where the direction of animation is known like in scrolling a page up-down or left-right, it may be preferable to rotate a clustered dot screen in a direction that is favorable to the direction of animated scrolling.

In some embodiments, with the half-toning process of step 302 producing only black and white images for the displaying pixels, one needs to only consider the following transitions:
white→black
white→white
black→white
white→white

In practice, the transitions of white→white and black→black may be left empty as with driving methods that utilizes relatively short pulses to change pixel grayscales (e.g. the Direct Update or DU method mentioned below), which will maintain a DC balance and also reduces transition appearance.

As described above, for some display applications, a display may make use of a “direct update” drive scheme (“DU” drive scheme). The DU drive scheme may have two or more than two gray levels, typically fewer than a gray scale drive scheme (“GSDS), which can effect transitions between all possible gray levels, but the most important characteristic of a DU drive scheme is that transitions are handled by a simple unidirectional drive from the initial gray level to the final gray level, as opposed to the “indirect” transitions often used in a GSDS, where in at least some transitions the pixel is driven from an initial gray level to one extreme optical state, then in the reverse direction to a final gray level; in some cases, the transition may be effected by driving from the initial gray level to one extreme optical state, thence to the opposed extreme optical state, and only then to the final extreme optical state—see, for example, the drive scheme illustrated in FIGS. 11A and 11B of the aforementioned U.S. Pat. No. 7,012,600. Thus, present electrophoretic displays may have an update time in grayscale mode of about two to three times the length of a saturation pulse (where “the length of a saturation pulse” is defined as the time period, at a specific voltage, that suffices to drive a pixel of a display from one extreme optical state to the other), or approximately 700-900 milliseconds, whereas a DUDS has a maximum update time equal to the length of the saturation pulse, or about 200-300 milliseconds.

In some embodiments, the white→black mentioned above can include a pulse driven with positive polarity voltage for pulse length frame, and the black→white transition can include a pulse driven with negative polarity voltage, where the pulse length can be between 15 to 21 frames at a temperature of roughly 25 Celsius.

However, for smooth video transitions, the white→black and black→white transitions will be configured to be interruptible. Preferably, at every update frame since in an animation mode a given pixel may require change of optical states to black or white at every frame.

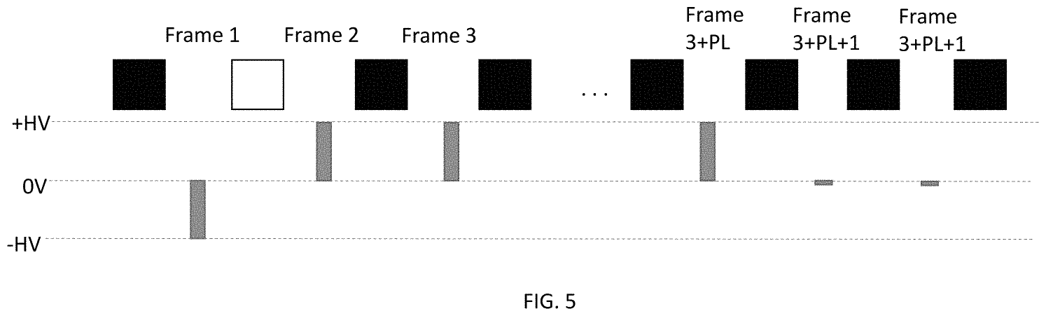

FIG. 5 illustrates an example of waveform that may be applied on a series of changes of pixels states at each frame. To maintain a DC balance, the following rules may be applied at each frame:

Rule #1: Apply a single frame negative polarity voltage when a pixel switches from black to white and a single frame positive polarity voltage when a pixel switches from white to black.

Rule #2: continuously apply a single frame voltage for an unchanged state until pulse length is reached in which case subsequent update to the same state will be driven with zero volt.

Rule #3: at the end of an animation sequence, apply the left over impulse potential to reach desired black and white states and completes the DC balancing cycle.

In practice, a waveform of n frames in duration may be used to permute all the possible voltage combinations of −15 volts, 0 volts, and +15 volts required to drive the pixels. Which gives a total of nⁿ or n³ in this case, of possible voltage combinations. Such list of voltage combination (e.g., n³) is possible to implement with a 5 bit waveform look up table (LUT), which provides 32 waveform slots. In some other embodiments, with a 4-bit waveform LUT, which provides 16 waveform slots, n² voltage combinations can be achieved.

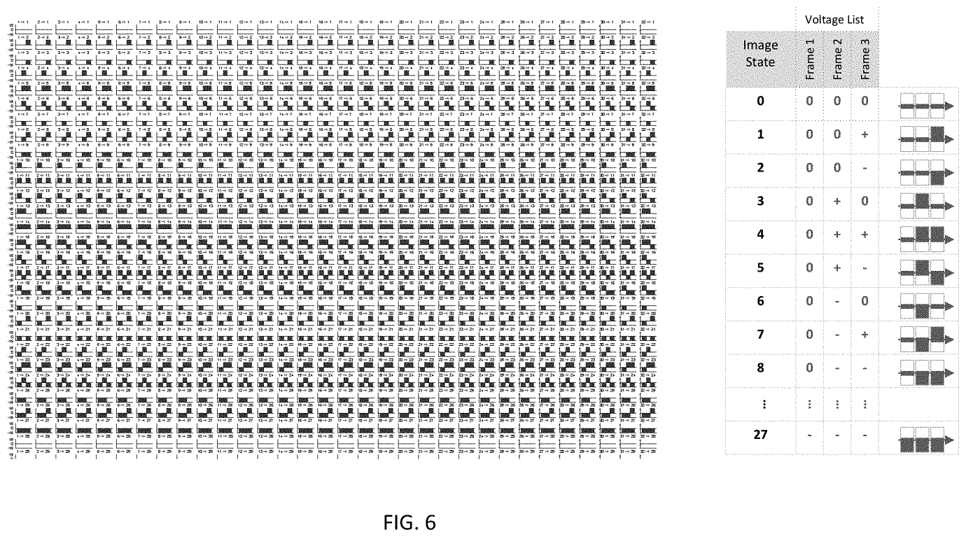

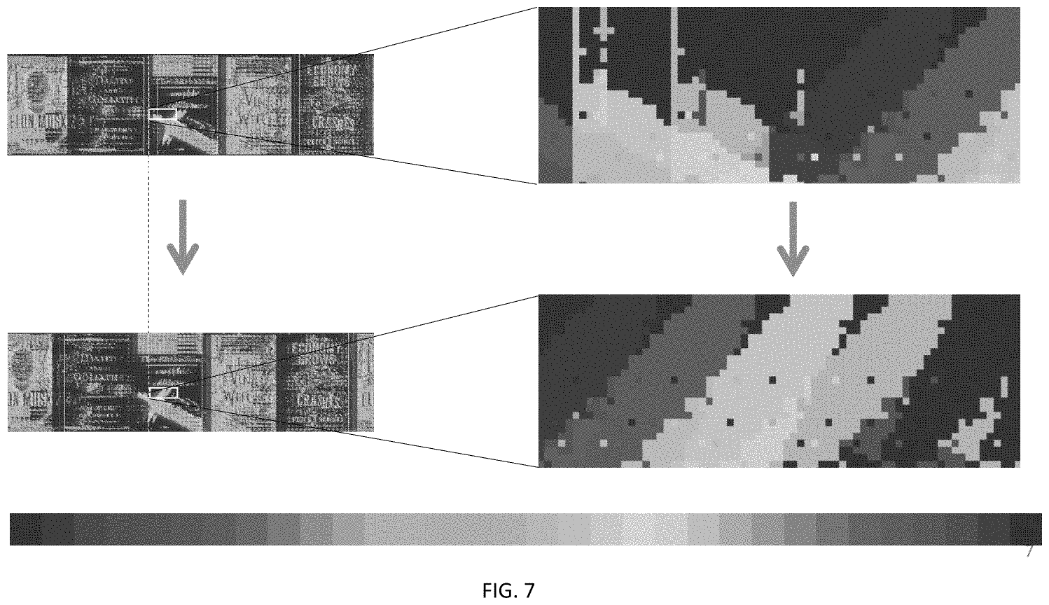

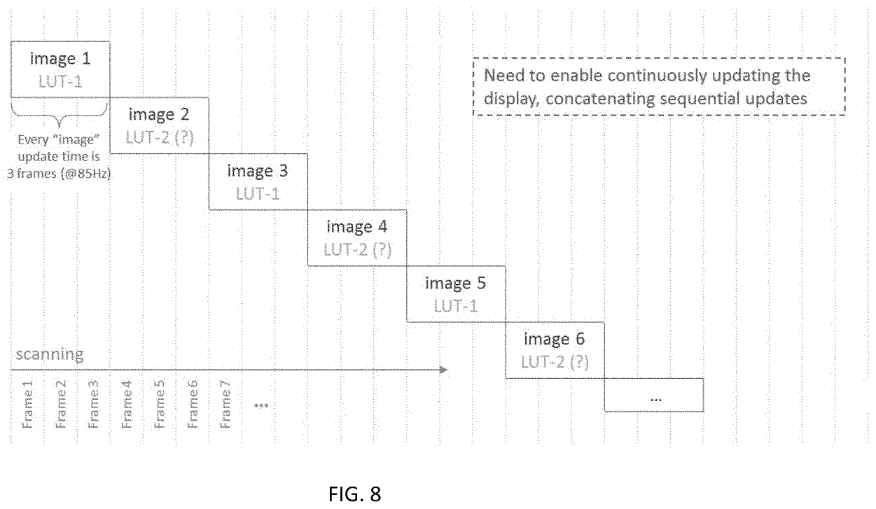

Referring now to FIG. 6, FIG. 6 illustrates a LUT with n³ voltage combinations, and where 27 waveforms can be generated. In some embodiments, an image processing algorithm can assign appropriate LUT states to the series of images to give an illusion of a smooth animation. Shown in FIG. 7 is an example of the image states that is assigned to the appropriate waveform LUT to generate a smooth scrolling animation. In some cases, where the waveforms are more than 1 frames in duration (e.g., n>1), one can concentrate the sequential images as shown in FIG. 8. In such cases, an EPD controller may use its pipeline updating capability to continuously que these images in a pipeline image buffer.

Furthermore, specialized waveforms may be utilized to clear artifacts such as blooming and/or ghosting at the end, or during a video updating. In some embodiments, this artifact clearing may be performed when the display process comes out of the black and white dither pattern to the original last gray scale image. For example, monopole waveforms may be used to clear artifacts on the white or black states with the use of post drive discharging.

It will be apparent to those skilled in the art that numerous changes and modifications can be made to the specific embodiments of the invention described above without departing from the scope of the invention. Accordingly, the whole of the foregoing description is to be interpreted in an illustrative and not in a limitative sense.

1. A method for driving an electro-optic display having a plurality of display pixels, the method comprising:
dithering a grayscale image into a black and white image;
updating the plurality of display pixels to display the black and white image; and
converting the black and white image back to the grayscale image.

2. The method of claim 1 further comprising applying a waveform configured to remove artifacts from the plurality of display pixels.

3. The method of claim 1, wherein the step of dithering the grayscale image into a black and white image comprises using a half-toning algorithm.

4. The method of claim 3, wherein the half-toning algorithm is a green noise half-toning algorithm.

5. The method of claim 1, wherein the step of dithering the grayscale image into a black and white image comprises using a clustered half-toning map.

6. The method of claim 1, wherein the step of updating the plurality of display pixels comprises applying a single frame negative polarity voltage to a display pixel when the display pixel switches from a black optical state to a white optical state.

7. The method of claim 1, wherein the step of updating the plurality of display pixels comprises applying a single frame positive polarity voltage to a display pixel when the display pixel switches from a white optical state to a black optical state.

8. The method of claim 1 wherein the step of updating the plurality of display pixels comprises using waveforms with n frames, n being an integer number.

9. The method of claim 8 wherein n=3.

10. The method of claim 8 wherein the step of updating the plurality of display pixels comprises using nⁿ waveforms.

11. The method of claim 8 wherein the step of updating the plurality of display pixels comprises using 27 waveforms.

12. The method of claim 1, wherein the step of updating the plurality of display pixels is substantially DC balanced.

13. The method of claim 1 wherein the electro-optic display is an electrophoretic display having an electro-optic medium.

14. The electro-optic display of claim 13 wherein the electro-optic medium is a rotating bichormal member or electrochromic medium.

15. The electro-optic display of claim 13 wherein the electro-optic medium is an electrophoretic medium comprising a plurality of charged particles in a fluid and capable of moving through the fluid on application of an electric field to the electro-optic medium.
